(19) United States
(12) Patent Application Publication
(10) Pub. No.: US 2025/0281834 A1
(43) Pub. Date: Sep. 11, 2025

(54) SERVICE PROVIDING APPARATUS PROVIDING COMMUNICATION WITH FRIEND USING WIDGETS AND OPERATION METHOD OF THE SERVICE PROVIDING APPARATUS

(71) Applicant: Nexon Korea Corporation, Seongnam-si (KR)

(72) Inventors: Cheol Min SHIN, Seongnam-si (KR); Sang Hyuk LEE, Seongnam-si (KR); Sang Sik EOM, Seongnam-si (KR); Na Eun LEE, Seongnam-si (KR); Jung Kyu YE, Seongnam-si (KR); Sung Ho MOON, Seongnam-si (KR)

(21) Appl. No.: 19/066,044

(22) Filed: Feb. 27, 2025

(30) Foreign Application Priority Data
Mar. 7, 2024 (KR) 10-2024-0032712
Jul. 9, 2024 (KR) 10-2024-0090464

(51) Int. Cl. A63F 13/537; A63F 13/79; G06F 3/04817

(52) U.S. Cl. CPC A63F 13/537; A63F 13/79; G06F 3/04817

(57) ABSTRACT

A service providing apparatus providing communication with friends using widgets, and an operation method of the service providing apparatus are proposed. The method includes displaying a friend widget on a screen of a user, and displaying status information of a friend on the friend widget, in which the status information of the friend includes information retrieved from a linked game.

### BACKGROUND

### Technical Field

Embodiments disclosed in this specification relate to a service providing apparatus providing communication with friends using widgets, and an operation method of the service providing apparatus.

### Description of the Related Art

A widget refers to a small element or component that users can interact with in a user interface. Widgets can appear in various forms, and for example, there are a compact application that shows weather information, a calendar, a clock, a stock price, and a news feed.

Widgets are typically added to a desktop or a dashboard, thereby enabling users to quickly check desired information. Various widgets can be used on a smartphone, a tablet, and a computer.

### SUMMARY

Embodiments disclosed in this specification have an objective of providing a service providing apparatus providing communication with friends that can overcome the limitation of games, which is inconvenience in the process of accessing games, using widgets, and an operation method of the service providing apparatus.

Further, embodiments disclosed in this specification has an objective of providing a service providing apparatus providing communication with friends that can provide opportunities for interactions and meeting with various friends by matching friends to be displayed on widgets and that can encourage a user to customize his/her character, and an operation method of the service providing apparatus.

A method of providing communication with friends using widgets according to an embodiment includes displaying a friend widget on a screen of a user.

The method of providing communication with friends using widgets according to an embodiment may further include displaying status information of a friend on the friend widget, wherein the status information of the friend may include information retrieved from a linked game. The status information of the friend may include at least one of a disconnection location, pet information, guild membership information, and a level of the friend in the linked game.

The method of providing communication with friends using widgets according to an embodiment may further include: displaying a homepage of the friend on the screen of the user when receiving click information on the friend widget of the user; and storing history information with the friend related to the friend widget of the user.

According to the service providing apparatus providing communication with friends using widgets, and the operation method of the service providing apparatus of an embodiments disclosed in the specification, it is possible to overcome the limitation of games, which causes inconvenience in the process of accessing games, using widgets.

Further, according to the service providing apparatus providing communication with friends using widgets, and the operation method of the service providing apparatus of an embodiments disclosed in the specification, it is possible to provide opportunities for interactions and meeting with various friends by matching friends to be displayed on widgets and it is possible to encourage a user to customize his/her character.

### BRIEF DESCRIPTION OF THE DRAWINGS

FIG. 1 is a configuration diagram of a service providing apparatus providing communication with friends using widgets according to an embodiment;

FIG. 2 is an exemplary diagram of a friend widget showing messages by friends;

FIG. 3 is an exemplary diagram of a user's homepage;

FIG. 4A is an exemplary diagram of a friend widget displayed on a user's screen before and after matching with a friend;

FIG. 4B is an exemplary diagram of a friend widget displayed on a friend's screen before and after matching with a friend;

FIG. 4C is an exemplary diagram of a user's full screen after matching with a friend; and

FIG. 5 is a flowchart of a method of providing communication with friends using widgets according to an embodiment.

### DETAILED DESCRIPTION

Hereafter, a service providing apparatus providing communication with friends using widgets according to embodiments of the present disclosure and an operation method of the service providing apparatus are described in detail with reference to the accompanying drawings. The following embodiments of the present disclosure are provided only to exemplify the present disclosure and are not intended to limit or restrict the scope of the present disclosure. Matters that can be readily inferred by those skilled in the art from the detailed description and embodiments of the present disclosure should be construed as falling within the scope of the present disclosure.

The term “character” used in this specification refers to a virtual figure or agent designed to humanize or add an emotional aspect to interactions between a user and an application program. The term “character” may also be referred to as “avatar”, and in this specification, “character” and “avatar” are used interchangeably.

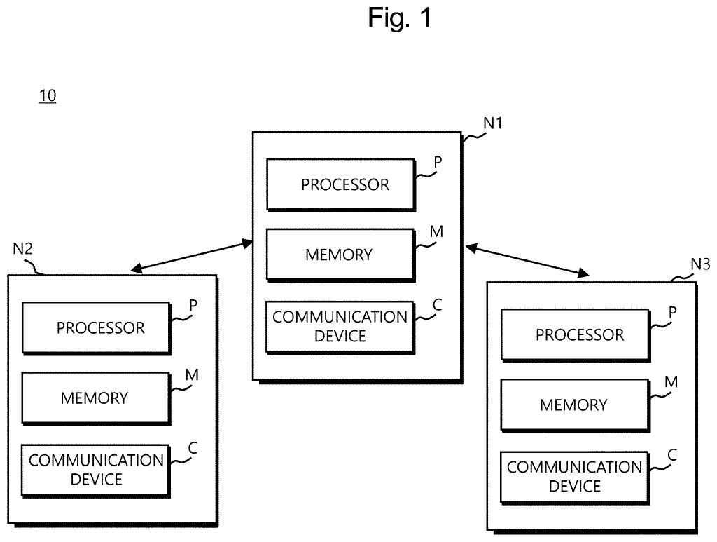

FIG. 1 is a configuration diagram of a service providing apparatus 10 providing communication with friends using widgets according to an embodiment.

The service providing apparatus 10 providing communication with friends using widgets may be a service providing server, a user terminal, a game system including a service providing server and a user terminal, or an independent single apparatus. That is, the service providing apparatus 10 may be implemented as a terminal, may be implemented as a server, and may be implemented as a structure in which a terminal and a server are integrated.

For example, the service providing apparatus 10 is provided as multiple nodes N1, N2, and N3 in FIG. 1, but the service providing apparatus 10 may include at least one N1, N2, N3 of the multiple nodes N1, N2, and N3, and the nodes N1, N2, and N3 each may be one of a service providing server or a user terminal.

Further, the nodes N1, N2, and N3 each may include at least one processor P, at least one memory M, and at least one communication device C. Instructions that can be executed by the at least one processor P are included in at least one memory M and the at least one processor P executes the instructions. The at least one communication device C is a device for communication of a corresponding node N1, N2, and N3 with external devices.

At least some of the nodes N1, N2, and N3 may have various input devices including a keyboard receiving data and various output devices such as a display for displaying data, etc. on a screen.

The service providing apparatus 10 can receive setting information of a friend widget from a user, create the friend widget, and display the friend widget on the user's screen, that is, a main screen. A friend widget is a tool that facilitates interaction with friends.

Setting information of the friend widget from the user may be information for selecting a specific friend to be displayed on the friend widget or information for requesting friend matching without selecting a specific friend.

The friend widget may display status information of a friend, the friend's character, the friend's chat window, a user's character, and at least one icon indicating unread history information by the user. Additionally, the friend widget may further display the user's chat window.

The status information of the friend can be uploaded and displayed on the friend widget. The status information of a friend refers to the activity information of the friend on the online platform.

The status information of the friend may include information retrieved from a linked game. That is, the status information of the friend may include activity information of the friend in the linked game. The linked game refers to a game linked to an application program installed in the service providing apparatus 10. The information between the service providing apparatus 10 and the linked game is unidirectional.

Further, the status information of the friend including the activity information of the friend in the linked game may include at least one of the disconnection location, pet information, guild membership information, and a level of the friend in the linked game.

The status information of the friend including the activity information of the friend in the linked game may further include at least one of current connection information of the friend in the linked game and the current location of the friend in the linked game. The user needs to move to a corresponding location using the disconnection location or the current location of the friend in the linked game, that is, map information in order to easily play the game with the friend. The pet information, guild membership information, and level of a friend in the linked game could be usefully utilized as materials for communication with the friend.

For reference, a pet is an animal or creature that follows a player and provides various benefits in a game. The pet can play roles such as helping in battles, assisting in collecting items, or improving the stats of a player. The pet information may include detailed information of the pet such as the type, level, stats, evolution status, and owner of the pet.

A guild is a group formed by multiple players coming together. Guild members can help each other and achieve goals in the game or participate in guild-exclusive content such as a guild war and a guild mission. The guild membership information may include information related to the guild such as which guild the player belongs to, the rank or role of the player in the guild, and the guild join date.

A level refers to a value that increases each time experience points (XP) of a player or a pet satisfy a predetermined condition.

Through linking with a game, it is possible to overcome the convenience of the game, particularly, the convenience of the process of accessing a PC game. Further, it is possible to easily checking the game information of a friend in daily life, so it is possible to easily provide opportunities to play games with friends.

The service providing apparatus 10 may retrieve items, which are used in a game, from a game server through linking with the game. Accordingly, it is possible to coordinate characters using not only unique items in an application, but items in the game.

The status information of the friend may further include activity information in an application that is operated in the service providing apparatus 10.

Comments of the friend may be displayed in a chat window included on the friend widget. A comment of the friend is a message that the friend has posted on the character widget of the friend. The character widget of the friend may be a widget displayed on the home page of the friend. Similarly, a comment of the user can also be displayed on the friend's screen using a chat window included on the friend widget. The comment of the user is a message that the user has posted on the character widget of the user. The character widget of the user may be a widget displayed on the home page of the user.

A chat window may be displayed in the form of a speech bubble, and a user and a friend can continuously check messages of the counterparts by monitoring comments in the chat window of the counterparts, so the user and the friend can chat.

Furthermore, when both the user's character and the friend's character are displayed together on the friend widget, their respective chat windows may be displayed adjacent to each character, allowing for the monitoring of mutual conversation. Additionally, depending on the user's settings, comments displayed in the chat window of the friend widget may be automatically translated and shown in a set language.

The service providing apparatus 10 can store history information of the friend related to the friend widget on a user's screen.

The history information may include at least one of a message generated by the friend and an occurrence record of a preset event related to the friend widget. By storing history information for each friend, the user can later access and reminisce about past interactions on the user's homepage. This is for storing records of encounters by chance to be used as communication materials because it is difficult to constantly detect when the history of the friend widget is exposed and giving notifications such as push would make it spam-like. By recording and storing history information, user's setting records are also stored, so it is possible to check in which situation the user met the friend. Further, it is not just about placing the friend widget, but also about being able to check who the user has met by coming in once in a while.

The message generated by the friend is a kind of note and may include at least one of a message left by the friend on the user's homepage and a log file that is automatically created when the friend visits the user's homepage.

The occurrence record of the preset event may be implemented in the form of a snapshot. That is, a snapshot is a record that captures a scene when the corresponding event occurs. The preset event, for example, may be the case when the coordinate of the user's character or a background is changed, the case when the chat window of the user is changed, and the case when the chat window of the friend displayed on the friend widget is changed.

Unread history information by the user may be displayed on the friend widget by an icon such as a note.

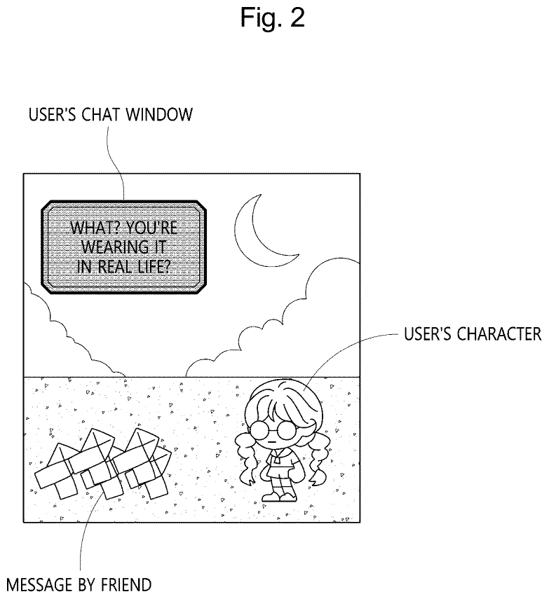

FIG. 2 is an exemplary diagram of the friend widget showing messages by friends.

For reference, in FIG. 2, messages by at least one friend are shown in the form of note and there is no currently matched or selected friend. As can be seen from FIG. 2, multiple messages can be accumulated. However, only five note icons are shown in FIG. 2, and when messages over a predetermined number are accumulated, the upper limit of icon to be displayed can be set in advance.

In this way, it is possible to represent that there are messages without accessing the application. Since when a message by the friend is displayed as a push or a badge, it might appear as something, which must be clicked, and give a sense of pressure, so the use of an icon to display a message without a notification is a form of emotional expression with less burden.

When the user clicks on history information, that is, an icon, the user is taken to the homepage of the user and can read the history information on the homepage.

That is, it is possible to induce loose communication with the friend rather than real-time communication with the friend by displaying history information on the friend widget. Further, the user can be reminded of pass memories by history information.

When receiving click information of the friend widget on the user's screen from the user, the service providing apparatus 10 can move to the homepage of a corresponding friend and display the homepage of the friend on the user's screen. That is, the homepage of a counterpart is directly connected by a single click on the friend widget without going through several steps, so convenience of a user can be increased.

A homepage is the page that appears when the user executes for the first time an application for operating the service providing apparatus 10 after installing the application or when a user executes the application after initializing. In detail, the homepage is also called “My Room” and refers to a feature or a section that allows a user to set up and manage a personalized space. This space can be customized by a user in accordance with the user's preferences and provides various tools and features for interaction with other users.

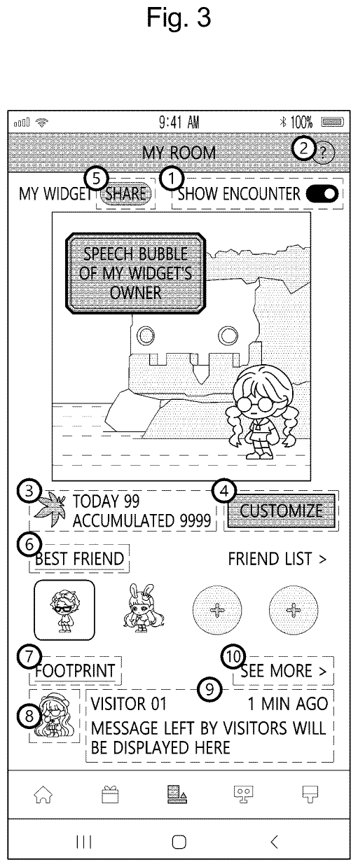

FIG. 3 is an exemplary diagram of the user's homepage.

On the user's homepage, information such as widget information, which includes the character of the user customized by the user, friend information, and the visit history (footprints) of visitors of the homepage may be displayed.

Further, the character of a currently matched friend may also be displayed on the user's homepage, depending on settings by the user. In this case, the user's homepage can show the character of the friend in the same way as the friend widget.

In detail, in FIG. 3, \textcircled{1} indicates whether to show the character of a currently matched friend, \textcircled{2} indicates FAQ, \textcircled{3} indicates the current status of the “like” currently received by the user from other friends, \textcircled{4} indicates whether to move to the user's character customization screen, \textcircled{5} indicates whether to share the character widget of the user, \textcircled{6} indicates a menu for selecting a friend by providing friend information, \textcircled{7} indicates the visit history of visitors of the user's homepage, and \textcircled{8} indicates the character coordination of a visitor. Further, \textcircled{9} indicates connection information left by a visitor.

Similarly, on a friend's homepage, widget information including the character of the friend customized by the friend, friend information, the visit history of visitors of the homepage, etc. are displayed. Further, the character of a currently matched user may also be displayed, depending on settings by the friend.

Hereafter, a method of selecting a friend when setting information of the friend widget by the user is information for selecting a specific friend to be displayed on the friend widget is described in detail.

The user can select a friend to be displayed on a friend widget from a friend list. The friend list may include at least one of the following: friends using the application; friends retrieved from linked games; and friends set by the user using unique identifiers.

The unique identifier may include a phone number, a virtual ID, a nickname, etc. Since the user can set friends using unique identifiers, it is possible to add corresponding friends even though the friends do not use the application or linked games.

When a specific friend is selected by the user, the character of the friend is displayed on the friend widget.

Hereafter, the case when setting information of a friend widget by the user is information for requesting friend matching without selecting a specific friend to be displayed on the friend widget is described in detail.

For example, when the user selects information for requesting preset friend matching, for example, a menu item ‘random friend widget’, new friends are periodically and randomly matched by the service providing apparatus 10 and the characters of the friends are displayed on the friend widget. If necessary, the information of matched friends may also be stored in the friend list of the user.

The service providing apparatus 10 may perform friend matching using the hobby, preference, and character coordination information, etc. of the user.

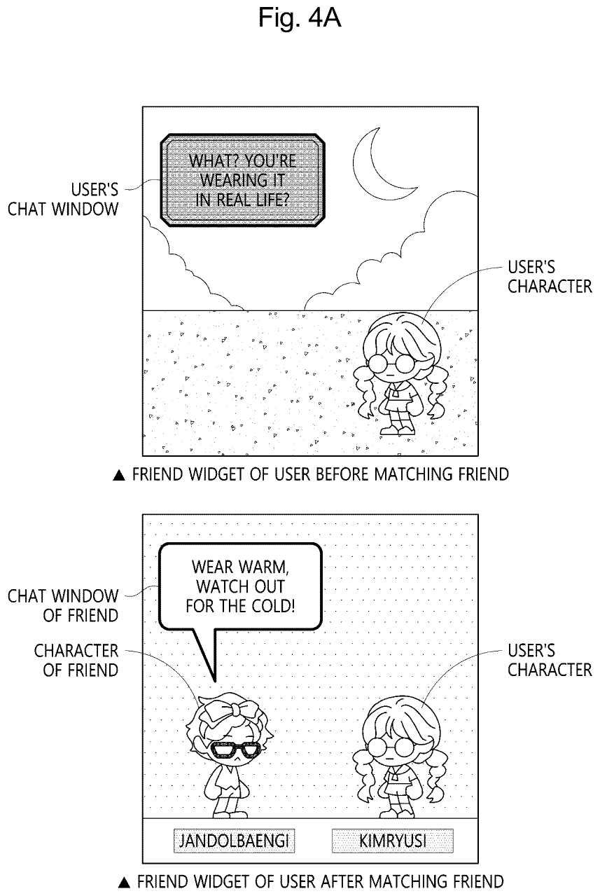

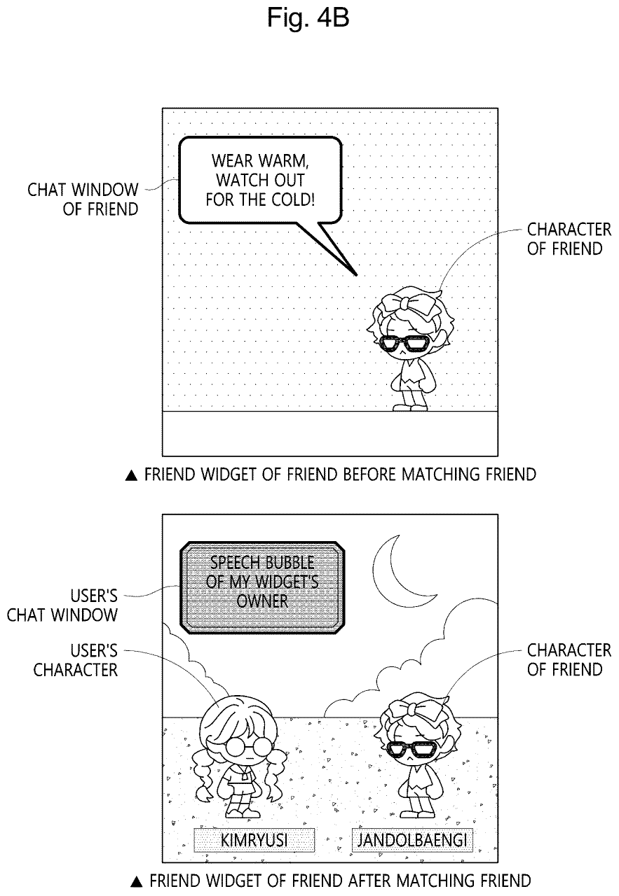

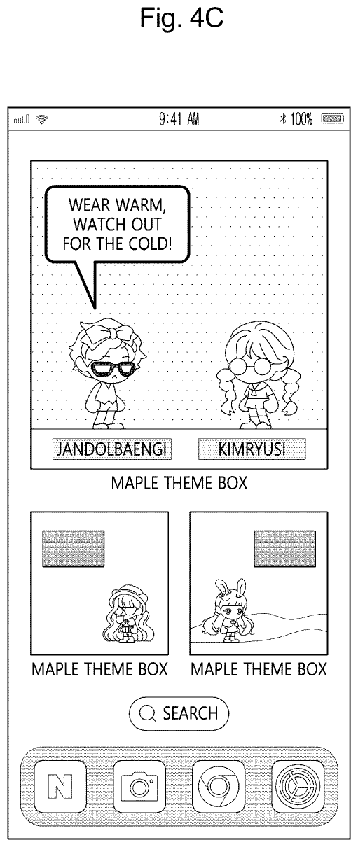

FIG. 4A and FIG. 4B are exemplary diagrams of the friend widget displayed on the user's screen and the friend widget displayed on the friend's screen before and after matching with the friend. FIG. 4C is an exemplary diagram of the user's full screen after matching with the friend.

Not only the character of the friend, but also, if necessary, the character of the user may be displayed on a friend widget. Multiple friend widgets may be displayed on the user's screen. The background of the friend widget after a friend is matched may be changed into a background set by the friend from the background set by the user.

The service providing apparatus 10 can match a friend to be displayed on the friend widget and display the character of the friend on the friend widget of the user's screen. The service providing apparatus 10 displays the character of the user on the friend widget on the screen of the matched friend. This means that, from the perspective of the user, a friend has been matched, and from the perspective of the friend, the user has been matched. That is, the service providing apparatus 10 matches two individuals with each other among the many who requested friend matching, and displays the characters of the counterparts on the friend widgets of the screens of the terminals of the two matched individuals, respectively.

Matching in this case may be performed by random matching, and a specific notification of matching such a message push or badge to the user is not set. That is, a matched friend may appear on the friend widget even when the user is not looking at the friend widget. Not setting a notification, as described above, is for inducing a user to frequently check the friend widget with expectation for a matched friend.

By implementing automatic and random meeting of virtual avatars through the friend widget, it is possible to induce a matched friend to be added as a friend on an application. That is, friend matching can be carried out in a way that resembles unexpectedly meeting a friend while walking down the street.

Further, since a randomly matched friend can visit the homepage of the user, it is possible to encourage the user to customize his/her character.

After matching a friend through the friend widget, the service providing apparatus 10 can display comments of the friend on the screen of the user using a chat window included on the friend widget. Similarly, after matching with the user, it is possible to display comments of the user on the screen of the friend using a chat window included on the friend widget. It is possible to continuously check messages of counterparts by monitoring comments of the counterparts, the user and the friend can chat.

When the user clicks on history information, the user is taken to the homepage of the user and can view the history information on the homepage, so it would be possible to induce the user to add a matched friend as a friend on the basis of the history of meeting with the friend.

The service providing apparatus 10, depending on settings by the user, can display whether there is a currently matched friend and the character of the friend together on the user's homepage.

The service providing apparatus 10 matches a new friend to be displayed on the friend widget and displays the character of the new friend on the friend widget of the user, thereby updating the friend widget. By periodically matching and updating new friends on the friend widget, the user can continuously meet various new friends through the friend widget.

A method of providing communication with friends using widgets according to an embodiment is described hereafter. The method of providing communication with friends using widgets according to an embodiment is performed by the service providing apparatus 10 described above, so the method inherently includes all the features of the service providing apparatus 10 even without separate explanation. Each step of the method of providing communication with friends using widgets can be performed by at least one processor P as an operation method of the service providing apparatus 10. That is, the method of providing communication with friends using widgets may be implemented in the form of a computer program that is executed by at least one processor P and the steps included in the method of providing communication with friends using widgets may be performed by one or more processors P.

The method of providing communication with friends using widgets may be implemented through a non-transitory computer-readable recording medium storing a program that can be executed in a computer by at least one processor P. The method of providing communication with friends using widgets may be implemented through a computer program stored in a recording medium.

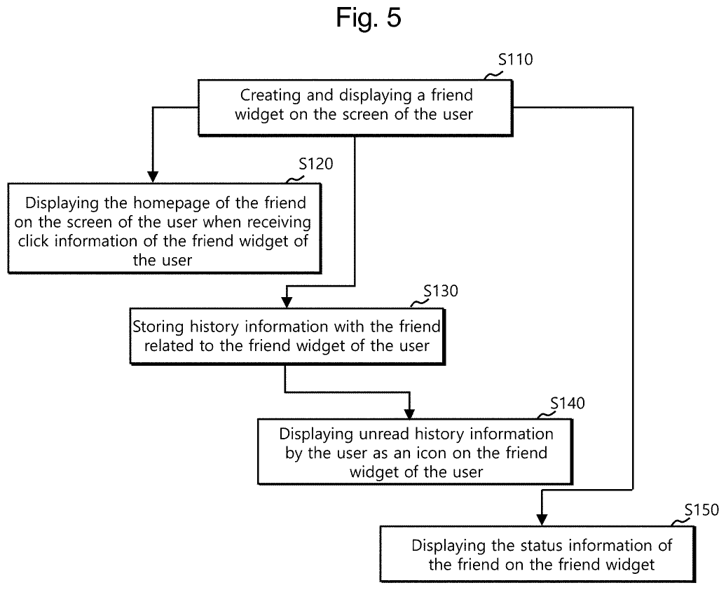

FIG. 5 is a flowchart of a method of providing communication with friends using widgets according to an embodiment.

As can be seen from FIG. 5, the method of providing communication with friends using widgets according to an embodiment may include receiving setting information of the friend widget from the user and creating and displaying the friend widget on the screen of the user (S110).

The setting information of the friend widget from the user in step S110 may be information for selecting a specific friend to be displayed on the friend widget or information for requesting friend matching without selecting a specific friend. When setting information of a friend widget from a user is information for selecting a specific friend to be displayed on the friend widget, the user can select the friend to be displayed on the friend widget from a friend list.

The method of providing communication with friends using widgets according to an embodiment may further include: displaying the homepage of the friend on the screen of the user when receiving click information of the friend widget of the user (S120); and storing history information with the friend related to the friend widget of the user (S130).

The history information may include at least one of a message generated by the friend and an occurrence record of a preset event related to the friend widget.

The method of providing communication with friends using widgets according to an embodiment may further include displaying unread history information by the user as an icon on the friend widget of the user (S140).

The method of providing communication with friends using widgets according to an embodiment may further include displaying the status information of the friend on the friend widget (S150).

The status information of the friend may include information retrieved from a linked game. In detail, the status information of the friend may include at least one of the disconnection location, pet information, guild membership information, and a level of the friend in the linked game. The linked game refers to a game that is integrated with the application installed to perform the method for communication with friends.

When setting information of the friend widget from the user is information for selecting a specific friend to be displayed on the friend widget, the method of providing communication with friends using widgets according to an embodiment may further include displaying the character of the friend on the friend widget (S210).

The friend list may include at least one of the following: friends using the application; friends retrieved from linked games; and friends set by the user using unique identifiers. The unique identifier may include a phone number, a virtual ID, a nickname, etc. Since the user can set friends using unique identifiers, it is possible to add corresponding friends even though the friends do not use the application or linked games.

The method of providing communication with friends using widgets according to an embodiment may further include: when setting information of the friend widget by a user is information for requesting friend matching without selecting a specific friend to be displayed on the friend widget, matching a friend to be displayed on the friend widget of the user (S310); displaying the character of the matched friend on the friend widget of the user (S320); displaying the character of the user on the friend widget of the screen of the matched friend (S330); displaying a chat window included on the friend widget of the user after matching the friend on the friend widget of the user (S350); and updating the friend widget by displaying the character of the new friend on the friend widget of the user (S360).

As described above, according to the service providing apparatus providing communication with friends using widgets of embodiments, and the operation method of the service providing apparatus, it is possible to overcome the limitation of games, which is inconvenience in the process of accessing games, using widgets, it is possible to provide opportunities for interactions and meeting with various friends by matching friends to be displayed on widgets, and it is possible to encourage a user to customize his/her character.

What is claimed is:

1. A method of providing communication with friends using widgets, the method comprising:
displaying a friend widget on a screen of a user.

2. The method of claim 1, further comprising:
displaying status information of a friend on the friend widget,
wherein the status information of the friend comprises information retrieved from a linked game.

3. The method of claim 2, wherein the status information of the friend comprises at least one of a disconnection location, pet information, guild membership information, and a level of the friend in a linked game.

4. The method of claim 1, further comprising:
displaying a homepage of the friend on the screen of the user when receiving click information of the friend widget of the user.

5. The method of claim 1, further comprising:
storing history information with a friend related to the friend widget of the user,
wherein the history information comprises at least one of a message generated by the friend and an occurrence record of a preset event related to the friend widget.

6. The method of claim 1, further comprising:
matching a friend to be displayed on the friend widget of the user;
displaying a character of the matched friend on the friend widget of the user; and
displaying a character of the user on a friend widget on a screen of the matched friend.

7. The method of claim 6, further comprising:
displaying a chat window included on the friend widget after matching the friend on the friend widget of the user.

8. The method of claim 6, further comprising:
matching a new friend to be displayed on the friend widget of the user; and
updating the friend widget by displaying a character of the new friend on the friend widget of the user.

9. A non-transitory computer-readable recording medium storing a program to perform the method of claim 1.

10. A service providing apparatus providing communication with friends using widgets, wherein the service providing apparatus displays a friend widget on a screen of a user.

11. The service providing apparatus of claim 10, wherein the service providing apparatus displays status information of a friend on the friend widget, and
the status information of the friend comprises information retrieved from a linked game.

12. The service providing apparatus of claim 11, wherein the status information of the friend comprises at least one of a disconnection location, pet information, guild membership information, and a level of the friend in the linked game.

13. The service providing apparatus of claim 10, wherein the service providing apparatus displays a homepage of the friend on a screen of the user when receiving click information of the friend widget of the user.

14. The service providing apparatus of claim 10, wherein the service providing apparatus stores history information with a friend related to the friend widget of the user, and
the history information comprises at least one of a message generated by the friend and an occurrence record of a preset event related to the friend widget.

15. The service providing apparatus of claim 10, wherein the service providing apparatus matches a friend to be displayed on the friend widget and displays a character of the friend on the friend widget of the user, and
displays a character of the user on a friend widget on the screen of the friend.

16. The service providing apparatus of claim 15, wherein the service providing apparatus displays a chat window included on the friend widget after matching the friend on the friend widget of the user.

17. The service providing apparatus of claim 15, wherein the service providing apparatus matches a new friend to be displayed on the friend widget of the user and updates the friend widget by displaying a character of the new friend on the friend widget of the user.
